(19) United States
(12) Patent Application Publication
(10) Pub. No.: US 2017/0151535 A1
(43) Pub. Date: Jun. 1, 2017

(54) CORRECTION FLUID STIRRING BODY STRUCTURE

(71) Applicant: MCAIDE ENTERPRISE CO., LTD., NEW TAIPEI CITY (TW)

(72) Inventor: MING-HUA YEN, NEW TAIPEI CITY (TW)

(21) Appl. No.: 14/954,907

(22) Filed: Nov. 30, 2015

(51) Int. Cl. B01F 13/00

(52) U.S. Cl. CPC B01F 13/0022; B01F 2215/005

(57) ABSTRACT

A correction fluid stirring body structure, in which the correction fluid is stored in a container, the container comprises an opening where a liquid outlet cover is mounted, and the opening is positioned on the container central axis, the distance from the opening edges to the container is H, and the stirring body comprises: a main body; and a guide block, which is positioned at one end of the main body, having a front section called a first guide surface and a rear section called a second guide surface, a displacement D is found between the guide block edge and the main body central line, in which D≧H. The two-section guide surface design smoothly guides the movement direction during guide stirring action.

### BACKGROUND OF THE INVENTION

1. Field of the Invention

The present invention relates to the field of text correction tools, and particularly relates to a stirring body structure to be used with correction fluids in order to stir the pigments used for the purpose of covering texts, and it can also increase the uniformity of fluid, and reduce the clogging phenomenon during use.

2. Description of the Related Art

When the commonly used writing equipments such as ballpoint pens, fountain pens, and ink pens are used on a paper, their ink quickly penetrates into the fibres of the paper and cannot be removed or erased by using an eraser for amendment/correction purposes. Therefore, nowadays, correction tapes or correction fluids etc. correction tools are used to make corrections on mistakes made during writing. Correction fluids are relatively more common these days and are easy to use for correction purposes. White correction fluid (commonly called as Liquid Paper) is used to cover writing errors and the purpose of covering writing errors is achieved by means of leaving behind a thin white film, after the solution left on the paper dries out. Afterwards, the correct text can be written on said thin white film and thus mistakes can be corrected easily.

Nowadays, correction fluid (Liquid Paper) products are found as white correction fluids filled in independent containers. Common white correction fluids are formed as solute blends of white pigments homogeneously dispersed in solutions that volatilize rapidly. Since the specific gravity of solutes (solid ingredients that have covering effect) are higher than the solution, therefore settlement/precipitation phenomenon would occur when the solution is not in use, and thus it would be very hard to maintain a homogeneous dispersion. As a result, most of the correction fluids are placed in containers as follows: A metal bar or a metal sphere etc. stirring body is used as a stirring tool before use, such that, when the metal bar or the metal sphere is used to make a reciprocating motion within the solution, it moves the solution together with the solute to produce a stirring effect, and thus the solute is homogeneously distributed within the solution. As a result, the drawback of having a film layer that is sometimes thick and sometimes thin during coating would not occur.

In various patent documents, besides round rods and spheres, another commonly seen type of these kinds of stirring bodies is encountered to be metal wire rods, which can also generate stirring effect by means of shaking. However, while stirring is made by this kind of stirring bodies, the shape of the container may be restrictive, i.e. dead spaces may occur during movement. These dead spaces are found at the junction points of containers and liquid outlet covers. Since the opening of the container corresponding to the liquid outlet cover is usually smaller, and thus causes formation of a displacement with the opening location, this displacement sometimes causes the rod-shaped or wire rod-shaped stirring body to be stuck at the end piece. As a result, the stirring body cannot go into the liquid outlet cover to perform stirring operation, and therefore the solute starts to accumulate within the liquid outlet cover. Over time, this starts to affect the smoothness of the discharged liquid, and even causes clogging problem and the liquid cannot be discharged/applied anymore. As a result, more improvement is required in the related technical field.

### SUMMARY OF THE INVENTION

In the light of the above given problems, a purpose of the present invention is to provide a correction fluid stirring body structure and use the front end of said stirring body structure in a two-section guide surface design, so that when stirring is made by shaking movement, it wouldn't be stuck at the dead spaces found within the container, and thus avoid the problem of non-homogeneous stirring. In this way, the deficiency of the prior art stirring bodies would be solved completely by homogeneously dispersing the solute found within the white correction fluid and ensuring favourable fluidity and covering effect.

In order to achieve the above said purpose, in the correction fluid stirring body structure according to the present invention, said correction fluid is stored in a container; said container comprises an opening on which a liquid outlet cover is mounted, and said opening is positioned on the central axis of said container; the distance from the edges of said opening to the container is referred to as H; and the stirring body structure comprises: a main body, and a guide block, which is positioned at one end of said main body, and the front section of which is called a first guide surface and the rear section is called a second guide surface. Said first guide surface and said second guide surface can individually have different slopes or curvatures. In addition, a displacement D is found between the largest edge part of said guide block and the central line of said main body, wherein D≧H. The two-section guide surface design of the guide block can smoothly guide the movement direction during guide stirring action with the gravity force or driving force, so that it wouldn't be stuck at any part of the container or the liquid outlet cover, and would improve uniformity (homogeneity) during stirring.

In the below given various embodiments, with the through-hole or groove kind of structures found inside or on the surface of the embodiments, the stirring of the correction fluid can be made in an even smoother and unhindered manner. For example: At least one first through-hole is positioned on the second guide surface, in which the first through-hole runs through the second guide surface, so that when the correction fluid is stirred, it can pass through said first through-hole and thus improve the smoothness of flow. Also, for example: At least one groove is positioned on the surface of the second guide surface, in which the groove is positioned on the surface of the guide block, so that when the correction fluid is stirred, it can pass through said groove and thus improve the smoothness of flow. Or, for example: A second through-hole is positioned at the central axis of the main body, in which the second through-hole runs through said guide block and said main body, so that when the correction fluid is stirred, it can pass through said second through-hole and thus improve the smoothness of flow. Or, for example: A plurality of third through-holes are radially positioned on the main body surface, so that when the correction fluid is stirred, it can pass through said third through-holes and thus improve the smoothness of flow.

Besides, said main body is movably positioned on the flat surface of said guide block, and when said guide block found at the front end is stuck and cannot be shaken, the rear section of said main body causes shaking movement towards the guide block and thus a similar stirring effect would be obtained, so that the correction fluid would be stirred homogeneously.

Also, the total length of said main body and said guide block is longer than the width of the container, which ensures that the guide block can face towards the liquid outlet cover direction during the stirring operation, so that, during stirring, the stirring body wouldn't turn over excessively and get stuck horizontally within the container and thus affect the stirring operation negatively. Moreover, any selection among the cambered surface, curved surface, or conical surface for the first guide surface and similarly any selection among the cambered surface, curved surface, or conical surface for the second guide surface, or no matter if a discontinuous setup or a continuous setup is used for the first guide surface and the second guide surface, all of these options would lead said stirring body to have the same guiding effect, and thus it would provide homogeneous stirring effect.

### BRIEF DESCRIPTION OF THE DRAWINGS

FIG. 1 is a schematic view of a preferred embodiment of the present invention;

FIG. 2 is a first schematic view of a using status of a preferred embodiment of the present invention;

FIG. 3 is a second schematic view of a using status of a preferred embodiment of the present invention;

FIG. 4 is a schematic view of another implementation mode of a preferred embodiment of the present invention;

FIG. 5 is a schematic view of another implementation mode of a preferred embodiment of the present invention;

FIG. 6 is a schematic view of another implementation mode of a preferred embodiment of the present invention;

FIG. 7 is a schematic view of another implementation mode of a preferred embodiment of the present invention; and

FIG. 8 is a schematic view of a further implementation mode of a preferred embodiment of the present invention.

### DETAILED DESCRIPTION OF THE PREFERRED EMBODIMENTS

The below given detailed description and relevant figures are provided for making the content of the present invention clear for the esteemed examination expert.

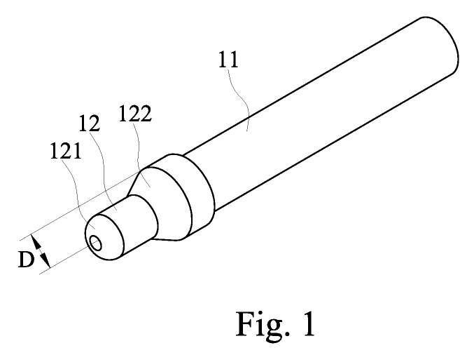

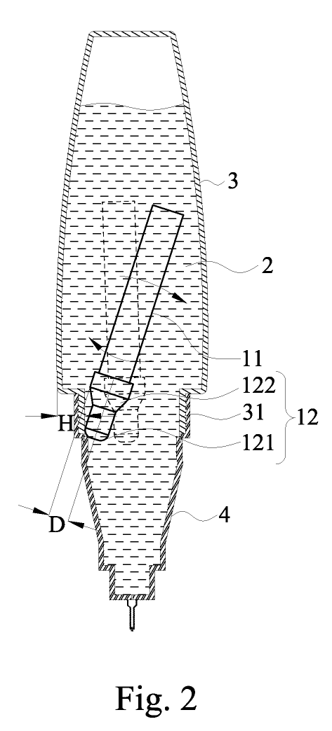

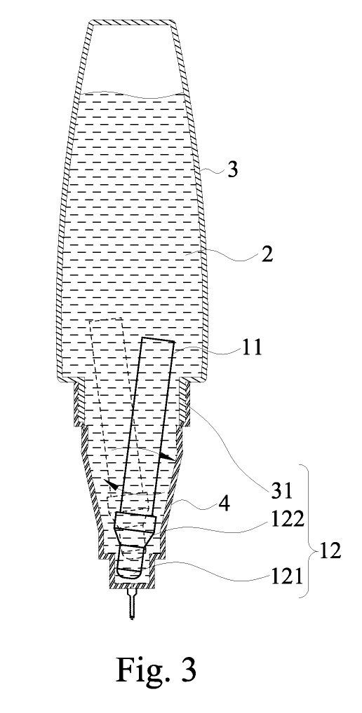

In FIGS. 1, 2, and 3-8, the drawings of the preferred embodiment structures and drawings of different situations during use, as well as different ways of implementation of the present invention are given. In the figures, the correction fluid stirring body structure 1 according to the present invention is shown, wherein said correction fluid 2 is stored in a container 3, said container 3 comprises an opening 31 where a liquid outlet cover 4 is mounted, and said opening 31 is positioned on the central axis of said container 3. The distance from the edges of said opening 31 to the container 3 is referred to as H. And the stirring body structure 1 comprises: a main body 11, as shown in the figures, said main body 11 presents a round bar shaped structure, and the length of said main body 11 is longer than the width of said container 3; and a guide block 12, which is shaped according to one end of the main body 11. Said guide block 12 uses a two-section guide surface design, in which the front section is called a first guide surface 121 and the rear section is called a second guide surface 122. Moreover, said two guide surfaces can be discontinuously or a continuously. In the present embodiment, said two guide surfaces are discontinuous, but if required, said two guide surfaces can also have a bullet-shaped design and form a single continuous surface. Moreover, the first guide surface 121 and the second guide surface 122 can individually be a cambered surface, a curved surface, or a conical surface. As shown in the figures, said first guide surface 121 is a cambered surface, while said second guide surface 122 is a conical surface, and as a result, both individually have different slopes or curvatures. Also, the design of their extending lengths can also be changed according different usage. In addition, there is a displacement D between the most outer edge of said guide block 12 and the central line of said main body 11, wherein D≧H. The two-section guide surface design of the present invention can smoothly guide the movement direction during guide stirring action, so that it wouldn't block any part of the container or the liquid outlet cover. This would improve uniformity during stirring, and prevent the clogging problem of the solute.

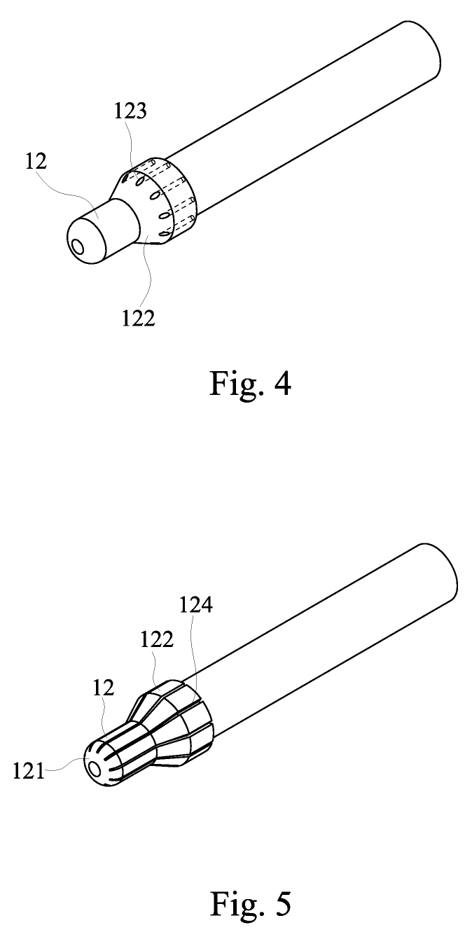

As shown in FIG. 4, the guide block 12 has a first through-hole 123 on the second guide surface 122 and. Said first through-hole 123 runs through said guide block 12, so that while being stirred, said correction fluid 2 can pass through said first through-hole 123 and increase the smoothness of the flow; and as shown in the figures, while it causes said correction fluid 2 to move towards the liquid outlet cover 4, said correction fluid 2 flows through its surface and the inner part of said first through-hole 123, which thus makes the movement more stable, smoother, and unhindered, and thus ensures improved stirring effect.

As shown in FIG. 5, the guide block 12, corresponding to the first guide surface 121 and the second guide surface 122, has a groove 124. Said groove 124 is positioned on the surface of said guide block 12, so that while being stirred, said correction fluid 2 can pass through said groove 124 and increase the smoothness of the flow; and as shown in the figures, the design of said groove 124 is made such that, while it causes said correction fluid 2 to move towards the liquid outlet cover 4, said correction fluid 2 flows through said guide block 12 and the groove 124 acts as a guide, which thus makes the movement more stable, smoother, and unhindered, and thus ensures improved stirring effect.

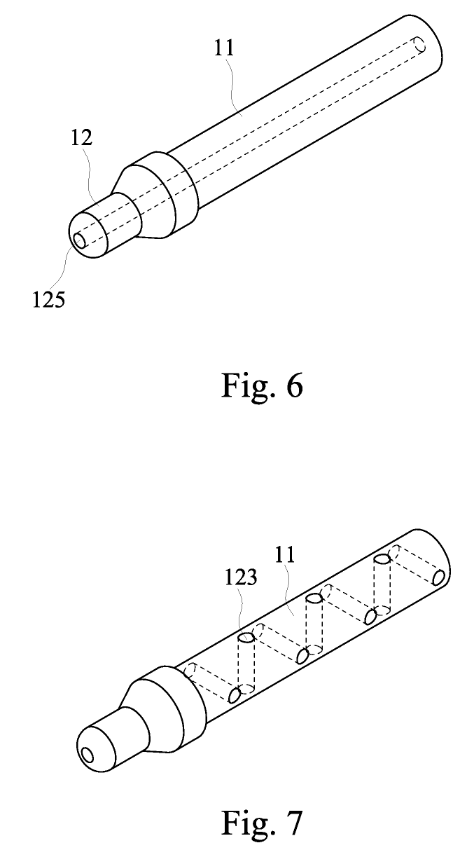

As shown in FIG. 6, a second through-hole 125 is positioned on the central axis of said main body 11. Said second through-hole 125 runs through said main body 11 and the sharp end of said guide block 12, so that while being stirred, said correction fluid 2 can pass through said second through-hole 125 and increase the smoothness of the flow; and as shown in the figures, while it causes said correction fluid 2 to move towards the liquid outlet cover 4, said correction fluid 2 flows through the surface of said guide block 12 and the inner part of said second through-hole 125, which thus makes the movement more stable, smoother, and unhindered, and thus ensures improved stirring effect.

As shown in FIG. 7, a plurality of third through-holes 126 are radially positioned on the main body 11 surface, so that when the correction fluid 2 is stirred, it can pass through said third through-holes 126 and thus improve the smoothness of flow. Besides improving the smoothness during flow, by means of passing through said third through-holes 126, said correction fluid 2 can also increase the stirring effect via turbulent flow.

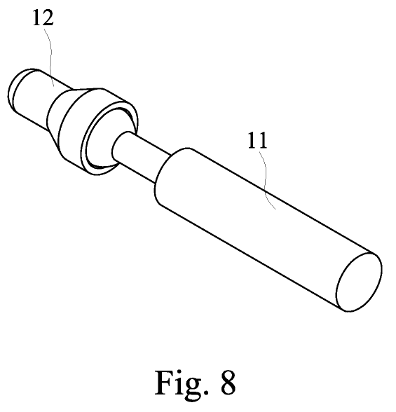

As shown in FIG. 8, in another embodiment, the main body 11 according to the present invention is movably positioned on one surface of said guide block 12, and therefore, when said guide block 12 enters into said liquid outlet cover 4, said main body 11 can still maintain its free swinging state, and thus it can improve the stirring effect.

What is claimed is:

1. A correction fluid stirring body structure, the correction fluid is stored in a container, the container comprises an opening where a liquid outlet cover is mounted, and the opening is positioned on a central axis of the container, and a distance from edges of the opening to the container is referred to as H, and the stirring body structure comprises:
a main body; and
a guide block, which is positioned at an end of the main body, and a front section of the guide block is a first guide surface and a rear section of the guide block is a second guide surface, the first guide surface and the second guide surface have different slopes or curvatures, and a displacement D is found between an outer most edge of the guide block and a central axis of the main body, wherein D≧H; a two-section guide surface design of the guide block can smoothly guide a movement direction during guide stirring action with an assistance of gravity force or driving force, so that it would not be stuck at any part of the container or the liquid outlet cover, and would improve uniformity during stirring.

2. The correction fluid stirring body structure according to claim 1, wherein at least one first through-hole is positioned on the second guide surface, in which the first through-hole runs through the second guide surface, so that when the correction fluid is stirred, it can pass through the first through-hole and thus improve the fluency of flow.

3. The correction fluid stirring body structure according to claim 1, wherein at least one groove is positioned on the second guide surface, such that the groove is positioned on a surface of the guide block, so that when the correction fluid is stirred, it can pass through the groove and thus improve the smoothness of flow.

4. The correction fluid stirring body structure according to claim 1, wherein a second through-hole is positioned at the central axis of the main body, such that the second through-hole runs through the guide block and the main body, so that when the correction fluid is stirred, it can pass through the second through-hole and thus improve the smoothness of flow.

5. The correction fluid stirring body structure according to claim 1, wherein a plurality of third through-holes are radially positioned on a surface of the main body, so that when the correction fluid is stirred, it can pass through the third through-holes and thus improve the smoothness of flow.

6. The correction fluid stirring body structure according to claim 1, wherein the main body is movably positioned on a flat surface side of the guide block.

7. The correction fluid stirring body structure according to claim 1, wherein a total length of the main body and the guide block is longer than a width of the container.

8. The correction fluid stirring body structure according to claim 1, wherein the first guide surface is a cambered surface, a curved surface, or a conical surface, and similarly, the second guide surface is a cambered surface, a curved surface, or a conical surface.

9. The correction fluid stirring body structure according to claim 1, wherein the first guide surface and the second guide surface are not continuously adjacent to each other.

10. The correction fluid stirring body structure according to claim 1, wherein the first guide surface and the second guide surface are continuous.
